(19) United States
(12) Patent Application Publication
(10) Pub. No.: US 2024/0126263 A1
(43) Pub. Date: Apr. 18, 2024

(54) METHOD FOR DETERMINING A SELECTION AREA IN AN ENVIRONMENT FOR A MOBILE DEVICE

(71) Applicant: Robert Bosch GmbH, Stuttgart (DE)

(72) Inventors: Elisa Rothacker, Vaihingen/Enz (DE); Matthias Holoch, Leonberg (DE); Sebastian Haug, Leinfelden-Echterdingen (DE)

(21) Appl. No.: 18/479,188

(22) Filed: Oct. 2, 2023

(30) Foreign Application Priority Data
Oct. 17, 2022 (DE) 10 2022 210 911.2

(51) Int. Cl. G05D 1/02

(52) U.S. Cl. CPC G05D 1/0214; G05D 1/0238; G05D 1/0246; G05D 1/0274

(57) ABSTRACT

A method for determining a selection area in an environment for a mobile device, in particular a robot. The method includes: providing sensor data obtained using a sensor system not associated with the mobile device in the environment, the sensor data characterizing a position and/or orientation of an entity in the environment; determining, based on the sensor data, the position and/or orientation of the entity in a map provided for navigation of the mobile device; providing specification data obtained using the sensor data, the specification data characterizing the selection area; determining the selection area in the map based on the specification data; and providing information about the selection area to the mobile device, and in particular instructing the mobile device to correspondingly take the selection area into account when navigating.

### CROSS REFERENCE

The present application claims the benefit under 35 U.S.C. § 119 of German Patent Application No. DE 10 2022 210 911.2 filed on Oct. 17, 2022, which is expressly incorporated herein by reference in its entirety.

### FIELD

The present invention relates to a method for determining a selection area in an environment for a mobile device, in particular a robot, as well as to a system for data processing, a mobile device, and a computer program for carrying it out.

### BACKGROUND INFORMATION

Mobile devices such as robots typically move around in an environment, particularly an environment or work area to be worked on, e.g. a residence or yard. Here, it can be provided that such a mobile device moves to a particular area within the environment, for example in order specifically to clean it or do work on it. However, it can also be provided that the mobile device is not to enter a certain area.

### SUMMARY

According to the present invention, a method for determining a selection area, as well as a system for data processing, a mobile device, and a computer program for carrying it out, are provided. Advantageous embodiments of the present invention are disclosed herein.

The present invention is generally concerned with mobile devices that move, or at least can move, in an environment or for example in a working area there. As mentioned above and to be explained in more detail, there may be not only areas in the environment in which the mobile device is to move, but also areas in which the mobile device is not to move, or is not permitted to move. In particular, the present invention is concerned with determining a selection area in such an environment. In this context, a selection area means, in particular, a part of the environment or the working area, e.g. a certain area in a particular room. In particular, the selection area can include an area to be worked on by the mobile device, e.g., an area to be processed or to be cleaned again, for example. However, the selection area can also include an area in which the mobile device is not allowed or not intended to move, a so-called no-go zone.

Examples of such mobile devices (or also mobile working devices) are e.g. robots and/or drones and/or also vehicles moving in partially automated or (fully) automated fashion (on land, water, or in the air). Robots include, for example, household robots such as cleaning robots (e.g. in the form of vacuuming and/or mopping robots), floor or street cleaning devices, construction robots or lawn mowing robots, but also other so-called service robots, as at least partially automated moving vehicles, e.g. passenger transport vehicles or goods transport vehicles (also so-called floor conveyors, e.g. in warehouses), but also aircraft such as so-called drones or watercraft.

In particular, such a mobile device has a control or regulating unit and a drive unit for moving the mobile device, so that the mobile device can be moved in the environment, for example also along a movement path or trajectory. In addition, a mobile device may have one or more sensors by which the environment or information in the environment can be acquired.

In the following, the present invention will be explained in particular using the example of a cleaning robot as a mobile device, although the principle can also be applied to other types of mobile devices.

Cleaning robots can be controlled, after installation, e.g. by a local control panel on the robot (e.g. start, stop, pause, etc.), by using an app (application or application program) on a smartphone or other mobile device, by voice command, etc. Automatic cleaning based on time programs is also possible. Likewise, a user can carry the cleaning robot to a location, for example, and start a room or spot cleaning from there.

In particular, however, cleaning certain locations or areas that, for example, were previously inaccessible (group of tables, toy, box in the way) or have currently become dirty are difficult to determine or define and communicate to the robot. In this case, reference can be made to a map (of the environment) which is intended for navigation of the cleaning robot or of the mobile device in general, and in particular which has also been created by the latter. Such a map will be discussed in more detail later.

For this purpose, a location can then be clicked on the map in the app, for example, or the robot can be carried directly to the location. Drawing no-go zones in the map is usually difficult because objects to be avoided (e.g. a high pile carpet) are often not detectable by the robot sensors, and thus cannot be seen in the map. The user must therefore infer the location of the carpet based on surrounding walls and other obstacles visible in the map. This is time-consuming and susceptible to error.

The map display in apps can be, for example, a 2D view (for example as an obstacle grid map). As a rule, however, a user will not be able to recognize a location or area that has not yet been cleaned. Rather, the user will not discover an area that has not yet been cleaned and still has to be cleaned until he is at the location. There then follows the described cumbersome and error-prone procedure for determining the area in the map for the cleaning robot.

Against this background, according to an example embodiment of the present invention, a possibility is provided for determining a selection area in the environment in which a mobile device such as a cleaning robot can (or cannot, as the case may be) move, using sensor equipment. It is expedient if the sensor equipment is not associated with the mobile device; e.g., it is sensor equipment in the environment. Such sensor equipment may be present, for example, at least in part in a mobile terminal device such as a smartphone or tablet, or in a stationary terminal device such as a smart home terminal device. For example, users of a cleaning robot or other mobile device often own such a terminal device, which is usually equipped with a variety of sensor equipment and corresponding capabilities. The inventors have found that information therefrom can now be linked to the map of the robot. The user can then select the area to be cleaned or some other area even more easily, for example by using the smartphone sensor equipment (e.g. camera). In principle, however, a sensor system associated with the mobile device can also be used.

A user can then, for example, start the cleaning job for the cleaning robot directly at the location to be cleaned by using his terminal device. Likewise, he can, for example, take a picture/video of e.g. a carpet directly on location with a smartphone in order to determine or define the selection area, in each case without the user himself having to use a map display and manually search for the desired location or area there.

For this purpose, according to an example embodiment of the present invention, sensor data obtained using the sensor system in the environment are provided. The sensor data characterize a position and/or orientation of an entity in the environment. Based on the sensor data, the position and/or orientation of the entity in the map provided for navigation of the mobile device is then determined. It should be mentioned that in many cases position and orientation can be necessary or at least expedient. One can then also speak of a pose here.

Various entities are possible here. According to an example embodiment of the present invention, the entity preferably includes a mobile terminal device, in particular a smartphone or a tablet, as already mentioned, which then also has at least part of the sensor equipment. The sensor system can then have a camera, for example, by which images of the environment are captured as sensor data. Based on the images, it is then possible to determine where the mobile device is located by matching it with information in the map. However, other types of sensor equipment can also be used, e.g. in the mobile terminal device, e.g., wireless radio modules that may interact with other infrastructure and allow position determination, IMUs, or lidar. In an environment outside a building, for example, GPS can also be a possibility as a sensor system.

According to an example embodiment of the present invention, the entity can also be or include the mobile device itself. However, the entity can also include a person in the environment, for example the user. It is then expedient if a stationary terminal device in the environment, in particular a smart home terminal device, includes at least part of the sensor equipment. Here, for example, a camera can be again be considered as sensor system. For example, a smart home camera can be used to acquire the position and/or orientation of a person in the environment. Given a known position and/or orientation of the camera in the map, the position and/or orientation of the person in the map can then be determined. Similarly, other sensor equipment of the stationary terminal device can be used, such as a microphone that receives a voice instruction from the user that cleaning is to take place at the position and/or orientation where the user is located. The sensor data relating to the position and/or orientation of the user can then be determined, for example, by analyzing the recorded voice (possibly taking into account the position and/or orientation of the microphone in the environment), and/or using a camera as sensor system. Although the position and/or orientation of the mobile terminal device can be determined using the sensors of the mobile terminal device, and the position and/or orientation of the stationary terminal device can also be determined using the sensors of the stationary terminal device, it is also possible for the position and/or orientation of the mobile terminal device to be determined using the sensors of the stationary terminal device, or vice versa.

According to an example embodiment of the present invention, the entity can moreover be or include for example contamination, or an object in the environment that stands in a relation to the selection area to be determined. The objects can be, for example, objects (such as Lego bricks, chairs) that have been moved, and a free area that has not yet been cleaned has now been created. In particular, the sensor system is then not part of the entity. It is also expedient here if a stationary terminal device in the environment, in particular a smart home terminal device, has at least some of the sensor equipment. Here, the sensor equipment of the stationary terminal device can be used to automatically detect particular areas that are for example to be cleaned, especially since in many cases a sensor system on the cleaning robot itself cannot detect these, or at least not as well.

According to an example embodiment of the present invention, determining the position and/or orientation of the entity in the map can also include in particular two or more stages. Here, the sensor data include first sensor data and further sensor data. Based on the first sensor data, a coarse position and/or orientation of the entity in the map is then determined, and based on the further sensor data and the coarse position and/or orientation—and alternatively or additionally the first sensor data—a finer or more precise position and/or orientation of the entity in the map is then determined. While the coarse position and/or orientation concerns e.g. only one room in a residence or a particular part of e.g. a larger room, the finer position and/or orientation can then relate to the specific location. This two-stage procedure allows a fast and accurate determination of the position and/or orientation of the entity.

Furthermore, in this context, according to an example embodiment of the present invention, it is expedient that the map is compatible with the sensor data, e.g., includes annotations compatible with, for example, camera images or Wi-Fi signatures (depending on the type of sensor equipment used) as sensor data.

Furthermore, according to an example embodiment of the present invention, specification data obtained using the sensor equipment are provided, the specification data characterizing the selection area. Based on the specification data, the selection area in the map is then determined. While the basic position and/or orientation, or the location where the selection area is to be, is initially determined using the sensor data, the specification data can now be used to determine in particular the concrete shape and/or size of the selection area.

Here, for example, the user can record the desired location using the mobile terminal device and its camera as sensor system, if necessary also by moving the mobile terminal device in the process, in order in this way to record the desired selection area. Likewise, however, the mobile device can simply be placed at a particular position around which a certain radius is then drawn that determines or indicates the selection area.

Preferably, according to an example embodiment of the present invention, the specification data thus characterize a position and/or orientation of the mobile terminal device in that, for example, the smartphone has been placed at the desired area. The position and/or orientation can be determined here for example using radio modules as sensors; it is also possible to use the sensor data. Furthermore, additional information is then provided that characterizes the selection area, in particular a diameter and/or an area of the selection area, in relation to the position and/or orientation of the mobile terminal device. For this purpose, a value for the diameter can be specified for example in an app of the mobile terminal device, which can for example already display the just-determined position and/or orientation in the map, or for example a circle or any other arbitrary shape can also be generated by an input via a touch display. The selection area is then determined based on the specification data and the additional information.

According to an example embodiment of the present invention, advantageously, the specification data include images captured using the camera. The specification data can then have been captured, for example, by the mobile terminal device, but also by the stationary terminal device, or the respective camera thereof. Here a user can, for example, capture images or a video (sequence of images) or a live capture or live view of the desired area. Furthermore, additional information is then provided that characterizes the selection area, in particular edges and/or an area of the selection area, in the images acquired by the camera. Here, for example, a user can specify the boundaries in the images or video by input into the terminal device, e.g. by specifying points that are automatically connected to form a boundary of the selection area. The selection area is then determined based on the specification data and the additional information.

This allows, for example, a floor structure such as a carpet to be segmented and entered into the map as the selection area, e.g., as a no-go zone. If the selection area includes an area to be cleaned, a cleaning can be performed at this location.

Information about the selection area is then provided to the mobile device, and in particular the mobile device is instructed to take the selection area into account when navigating; thus for example the mobile device can be instructed to navigate or drive to a particular selection area to be cleaned, or to omit a particular selection area (no-go zone) when navigating in the environment, i.e. not to drive there.

A system according to an example embodiment of the present invention for data processing includes means (i.e., a device) for carrying out the method according to the present invention, or its method steps. The system can be a computer or server, e.g. in a so-called cloud or cloud environment. The sensor and specification data can then be obtained there and, after determining the selection area, the information about this can be transmitted to the mobile device. Likewise, the system can be the mobile device or the stationary device, or a computing or processing unit at each of these. However, it is also possible that such a system for data processing is a computer or a control unit in such a mobile device.

The present invention also relates to a mobile device that is set up to obtain information about a selection area that has been determined according to a method according to the present invention. Also, as mentioned, the system for data processing can be included in the device. In particular, the mobile device is set up to take the selection area into account when navigating. Preferably, the mobile device has a control or regulating unit and a drive unit for moving the mobile device.

According to an example embodiment of the present invention, the mobile device is preferably designed as a vehicle moving in at least partially automated fashion, in particular as a passenger transport vehicle or as a goods transport vehicle, and/or as a robot, in particular as a household robot, e.g. a vacuuming and/or mopping robot, a floor or street cleaning device or lawn mowing robot, and/or as a drone, as already explained in detail above.

The implementation of a method according to the present invention in the form of a computer program or computer program product having program code for carrying out all the method steps is also advantageous, because this results in particularly low costs, especially if an executing control device is used for other tasks and is therefore present anyway. Finally, a machine-readable storage medium is provided having a computer program stored thereon as described above. Suitable storage media or data carriers for providing the computer program are in particular magnetic, optical, and electrical memories, such as hard disks, flash memories, EEPROMs, DVDs, and others. It is also possible to download a program via computer networks

(Internet, Intranet, etc.). Such a download can be done in wired or wireless fashion (e.g. via a WLAN network, a 3G, 4G, 5G or 6G connection, etc.).

Further advantages and embodiments of the present invention result from the description and the figures.

The present invention is shown schematically on the basis of an exemplary embodiment in the figures and is described below with reference to the figures.

### BRIEF DESCRIPTION OF THE DRAWINGS

FIG. 1 schematically shows a mobile device in an environment for explaining the present invention in a preferred embodiment.

FIG. 2 schematically shows a map for a mobile device.

FIG. 3 schematically shows a preferred embodiment of a sequence of a method according to the present invention.

### DETAILED DESCRIPTION OF EXAMPLE EMBODIMENTS

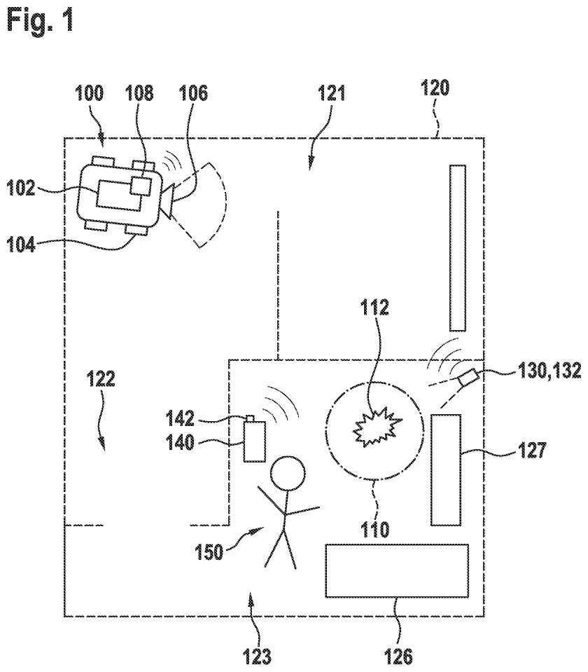

FIG. 1 schematically illustrates a mobile device 100 in an environment 120 for explaining the present invention, in a preferred embodiment. Mobile device 100 is for example a cleaning robot having a control or regulating unit 102 and a drive unit 104 (with wheels) for moving the cleaning robot 100 in environment 120, for example a residence. The environment or residence 120 has, as an example, three rooms 121, 122, 123 in which various objects 126, 127 such as furniture are disposed.

Furthermore, the robot vacuum cleaner 100 has as an example a sensor system 106 realized as a camera having a field of acquisition (indicated by dashed lines). For better illustration, the field of acquisition is chosen to be relatively small here; in practice, however, the field of view can be larger. Using the camera, objects in the environment can be acquired or determined. Likewise, a lidar sensor, for example, can also be present.

Furthermore, cleaning robot 100 has a system 108 for data processing, e.g. a control device, by which data can be received and transmitted, e.g. via an implied radio connection. With system 108, e.g. a method according to the present invention can be carried out.

Further shown is a person 150, who can be for example a user of cleaning robot 100. In addition, a mobile terminal device 140, e.g. a smartphone, with a camera 142 as sensor equipment is shown as an example. In addition, a stationary terminal device 130, e.g. a smart home terminal device, with a camera 132 as sensor equipment is shown as an example. Both mobile terminal device 140 and stationary terminal device 130 can for example also have or be designed as a system for data processing by which data can be received and transmitted, e.g. via an implied radio connection, and with which a method according to the present invention can be carried out.

Further, contamination 112 is shown in the environment 120, and more specifically, as an example, in the space 123. In addition, a selection area 110 is indicated. In the context of the present invention, as mentioned, such a selection area 110 can be determined that is then to be cleaned for example by cleaning robot 100, in particular in a targeted manner. As mentioned, such a selection area can also be a so-called no-go zone that is to be avoided by cleaning robot 100. It will be understood that it is also possible for a plurality of, and also all types of, selection areas to be present at the same time.

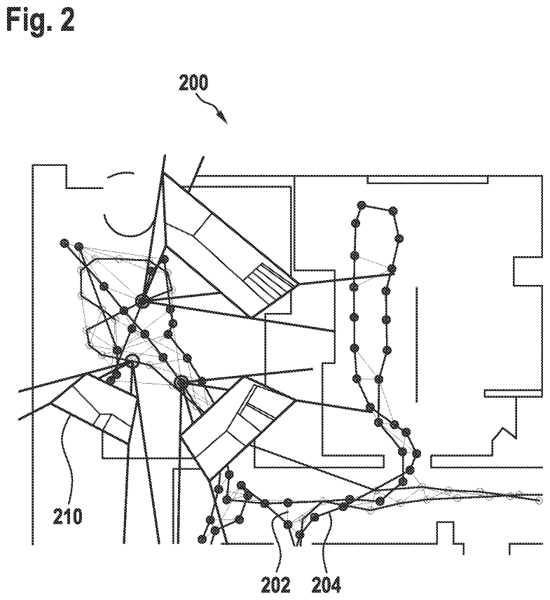

FIG. 2 schematically shows a map 200 for a mobile device such as the cleaning robot 100 of FIG. 1. As mentioned, sensor data from a sensor system such as camera 142 of mobile terminal device 140 are to be used to determine a position of an entity such as mobile terminal device 140 in such a map 200; i.e., the mobile terminal device is to be located.

For this purpose, it is expedient that the map has annotated data that matches the sensor equipment used. This means that the map includes, for example, annotations that are compatible or comparable with, for example, camera images or Wi-Fi signatures (depending on the type of sensor equipment used). As mentioned, such a map is usually created by the cleaning robot itself. For this purpose, the cleaning robot itself requires a corresponding sensor system, which is often already installed anyway or is used for the creation of the map.

One example is that the cleaning robot creates a camera-based map (e.g. ORB-SLAM). In such methods, a camera image is selected at regular intervals and becomes a fixed part of the map (so-called keyframes). For visual features in keyframes, for example a depth estimation (e.g. via bundle adjustment) is then performed.

Another example is that the cleaning robot creates a lidar-based map, but also has a camera installed (as mentioned in reference to FIG. 1). When mapping, for example, pictures are then regularly taken with the camera and added at the appropriate place on the map.

The map 200 of FIG. 2 is an example of such a map. There, node 202 and edge 204 of the map 200 are shown, and in addition images 210 are present at certain points.

Another example is that the cleaning robot creates a lidar-based map and has a Wi-Fi module for communication with the user and possibly the cloud. When mapping, for example an image of the available Wi-Fi access points and their signal strengths is then regularly added to the map.

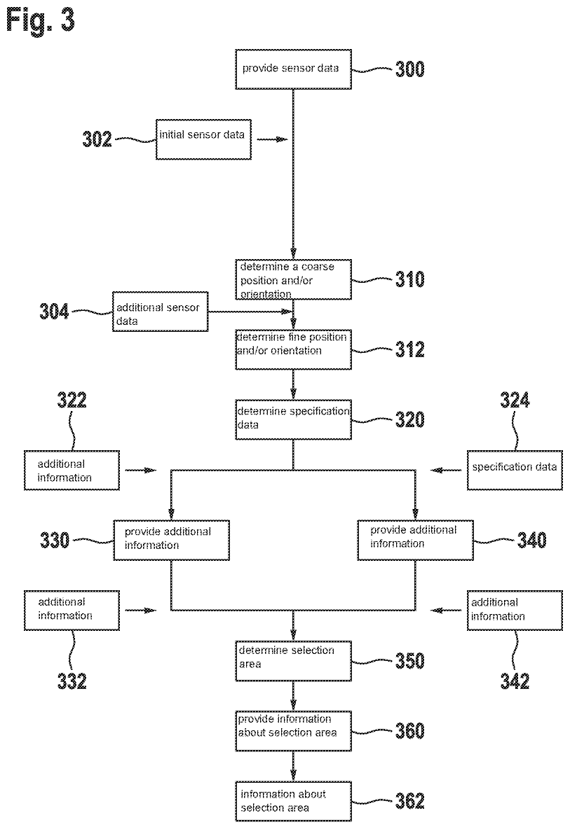

FIG. 3 schematically illustrates a sequence of a method according to the present invention in a preferred embodiment, explained below in particular with reference to FIG. 1.

For example, person (user) 150 may be in a room in the environment near a contaminant 112, as shown in FIG. 1. The user may carry a mobile terminal device 140 with a camera 142 as sensor equipment, as shown in FIG. 1. For the contamination 112 shown in FIG. 1, the selection area 110 is now to be determined that is then cleaned by the cleaning robot 100.

In a step 300, sensor data are provided. Based on these, the position and/or orientation of an entity in the map is determined. For example, the user may use mobile device 140 or its camera 142 to record a few data points, e.g. three images. Initial sensor data 302 (the images) are thus provided that are obtained using sensor equipment in the environment not associated with the mobile device. Based on the first sensor data 302, a coarse position and/or orientation of the mobile terminal device 140 as an entity in the map is then determined, in step 310. Thus, first a coarse localization is carried out.

During this, the first sensor data 302 are registered e.g. to the data in map 200. For this purpose, so-called “place recognition” methods can be used, for example FABMAP for camera images (cf. Cummins, Mark, and Paul Newman: “FAB-MAP: Probabilistic localization and mapping in the space of appearance,” The International Journal of Robotics Research) or as described for Wi-Fi in: Nowicki, Michal, and Jan Wietrzykowski: “Low-effort place recognition with WiFi fingerprints using deep learning,” International Conference Automation.

Here, for example only the similarity to existing data in the map is determined. It is to be mentioned that, depending on the type of the first sensor data, based thereon an exact, metric localization or at least sufficiently accurate localization is also already possible. However, if the quality of the first sensor data is not yet adequate, the localization accuracy may for example be sufficient to differentiate spaces such as rooms 121, 122, 123 in FIG. 1. For larger rooms, for example, areas in the rooms can also be differentiated (e.g. dining area vs. kitchen).

Furthermore, the camera of the mobile terminal device can then be used for example to determine the movement of the mobile terminal device for a short period of time. Additional sensor data 304 can thus be provided. A depth estimation can then be carried out for some keyframes. For this, methods can be used such as LSD-SLAM, in Engel, Jakob, Thomas Schops, and Daniel Cremers: “LSD-SLAM: Large-scale direct monocular SLAM,” European Conference on Computer Vision. The use of an inertial measurement unit (IMU) (e.g. also as part of the sensor equipment in the mobile terminal device) can further improve the results.

Based on the further sensor data 304 and the coarse position, a fine position and/or orientation of the entity in the map is then determined in step 312. Such a trajectory of the mobile terminal device (further sensor data) can be used for example to fuse multiple measurements of the first sensor data 302. As a result, the position and/or orientation of the mobile terminal device in the map can be determined significantly more precisely. By using depth estimation, for example pixels of a camera image currently displayed on the mobile device can be precisely mapped to a coordinate in the map. As mentioned, however, it may already be possible to make a sufficiently accurate determination of the position and/or orientation with the first sensor data. Equally, however, a third, or even further, stages may be useful for determining a sufficiently accurate position and/or orientation.

In a step 320, specification data are provided based on which selection area 110 in the map is determined. For this purpose, the user can place mobile terminal device 140 for example at the desired location, e.g. next to the contamination, or hold it over the relevant location of the contamination. Here the position can be determined for example using radio modules as sensors; it is also possible to use the sensor data (e.g. first or further sensor data 302, 304). Specification data 322 that characterize a position and/or orientation of the mobile terminal device are thereby provided.

Further, in step 330, additional information 322 is provided characterizing selection area 110, in particular a shape, e.g. a diameter and/or an area, of the selection area, in relation to the position of the mobile terminal device. For this purpose, the user can for example be shown the position and/or orientation of the mobile terminal device in the map, and the user can specify for example a desired radius or diameter, or generally the shape, by input. It is also possible for the user to determine the diameter without viewing the map, e.g. by selecting from a plurality of options. Likewise, the diameter or other shape of the selection area can also be defined automatically. The additional information can also be provided in such an automated manner. In addition, a selection or input can be made for example as to whether the corresponding location (selection area) is to be cleaned or marked as a no-go zone.

Alternatively or additionally, the user can capture or view the desired area e.g. using the camera of the mobile terminal device (or also of the stationary terminal device). Specification data 324 (the camera images) that characterize a position and/or orientation of the mobile terminal device are thereby provided. Further, in step 340, additional information 342 is provided that characterizes selection area 110, in particular edges or a shape of the selection area, in the images acquired by the camera. For this purpose, the user can, for example, selectively and precisely mark (in the sense of an “augmented reality zone”) particular areas in the camera image, e.g. manually with markers (or also e.g. by voice input to the mobile or stationary terminal device); this can also be done e.g. by input to the mobile terminal device. In addition, a selection or input can be made for example as to whether the corresponding location (selection area) is to be cleaned or marked as a no-go zone.

The selection area is thus determined, in step 350, based on the specification data 322 and/or 324 and the additional information 332 and/or 342.

In a step 360, information 362 about selection area 110 is then provided to the mobile device. In particular, the mobile device is also instructed to take the selection area into account when navigating.

As already mentioned, not only the mobile device can be used. Sensor data 302, 304 can also be acquired for example by stationary terminal device 130 or its camera 132. The sensor data then characterize the position of person 150 as an entity. Instead of or in addition to the camera, a microphone or other audio system of the stationary terminal device can also be used as sensor system. For example, voice recording can be used to determine the position and/or orientation of the person. Any cleaning that may be necessary in the selection area can then be started automatically or by voice command, for example.

Similarly, sensor data 302, 304 can be acquired for example by stationary terminal device 130 or its camera 132, thus characterizing the position of contamination 112 as the entity.

The stationary terminal device or a smart home system thus independently detects areas that have to be cleaned or that must or should be omitted from the cleaning. Here surfaces that were not accessible during a previous cleaning that are now free and can be cleaned can also be detected.

Cleaning/zoning can thus be performed automatically by the smart home system or, if appropriate, clarified with the user via an app, e.g. by asking whether a recognized area is to be left out of the cleaning, or e.g. that there appears to be a need for cleaning in this area and whether a cleaning should be initiated here, or that this area was not accessible during the last cleaning but is now free again and whether a cleaning should be initiated here.

In addition, a visual detection algorithm can be used to recognize the robot in the camera image during its missions. The stationary terminal device or its camera here queries the robot pose in the robot map, for example when the robot has been detected by the camera. This data allows poses in the robot map coordinate system to be mapped to the smart home camera coordinate system. In this way, areas detected in the camera image can be translated to areas in the robot map, and vice versa.

What is claimed is:

1. A method for determining a selection area in an environment for a mobile device, comprising the following steps:
providing sensor data obtained using a sensor system in the environment, the sensor data characterizing a position and/or orientation of an entity in the environment;
determining, based on the sensor data, the position and/or orientation of the entity in a map provided for navigation of the mobile device;
providing specification data obtained using the sensor system, the specification data characterizing the selection area;
determining the selection area in the map based on the specification data; and
providing information about the selection area to the mobile device, the information about the selecting area instructing the mobile device to correspondingly take the selection area into account when navigating.

2. The method as recited in claim 1, wherein the mobile device is a robot.

3. The method as recited in claim 1, wherein the entity includes a mobile terminal device, including a smartphone or a tablet, the mobile terminal device having at least part of the sensor system.

4. The method as recited in claim 1, wherein the entity includes a person in the environment.

5. The method as recited in claim 1, wherein the entity includes a contamination or an object in the environment related to the selection area to be determined.

6. The method as recited in claim 1, wherein a stationary terminal device in the environment has at least part of the sensor system, wherein the stationary terminal device includes a smart home terminal device.

7. The method as recited in claim 1, wherein the sensor system includes a camera, and the sensor data and/or the specification data include images acquired by the camera.

8. The method as recited in claim 1, wherein the sensor data include first sensor data and further sensor data, and the determination of the position and/or orientation of the entity in the map includes:
determining, based on the first sensor data, a coarse position and/or orientation of the entity in the map; and
determining, based on the further sensor data and the coarse position and/or orientation and/or the first sensor data, a fine position and/or orientation of the entity in the map.

9. The method as recited in claim 3, wherein the specification data characterize a position and/or orientation of the mobile terminal device, and the method further comprises:
providing additional information that characterizes the selection area, the additional information including a diameter of the selection area, in relation to the position and/or orientation of the mobile terminal device, and wherein the selection area is determined based on the specification data and the additional information.

10. The method as recited in claim 7, wherein the specification data include images acquired by the camera, and the method further comprises:
providing, in the images acquired by the camera, additional information that characterizes the selection area, the additional information including edges and/or an area of the selection area, wherein the selection area being determined based on the specification data and the additional information.

11. The method as recited in claim 1, wherein: (i) the selection area includes an area to be processed by the mobile device, or (ii) the selection area includes an area in which the mobile device is not permitted to move or is not intended to move.

12. A system for data processing, the system comprising:
a device configured to determine a selection area in an environment for a mobile device, the device configured to:
provide sensor data obtained using a sensor system in the environment, the sensor data characterizing a position and/or orientation of an entity in the environment;
determine, based on the sensor data, the position and/or orientation of the entity in a map provided for navigation of the mobile device;
provide specification data obtained using the sensor system, the specification data characterizing the selection area;
determine the selection area in the map based on the specification data; and
provide information about the selection area to the mobile device, the information about the selecting area instructing the mobile device to correspondingly take the selection area into account when navigating.

13. A mobile device, comprising:
a control or regulating unit; and
a drive unit configured to move the mobile device; wherein the mobile device is configured to obtain information about a selection area determined by:
providing sensor data obtained using a sensor system in the environment, the sensor data characterizing a position and/or orientation of an entity in the environment,
determining, based on the sensor data, the position and/or orientation of the entity in a map provided for navigation of the mobile device,
providing specification data obtained using the sensor system, the specification data characterizing the selection area,
determining the selection area in the map based on the specification data, and
providing information about the selection area to the mobile device, the information about the selecting area instructing the mobile device to correspondingly take the selection area into account when navigating;
wherein the mobile device is configured take the selection area into account when navigating.

14. The mobile device as recited in claim 13, wherein the mobile device is a robot, or a household robot, or a cleaning robot, or a floor or street cleaning device, or a lawn mowing robot, or a service robot, or a construction robot, or a vehicle moving in an at least partially automated manner, or a passenger transport vehicle, or a goods transport vehicle, or a drone.

15. A non-transitory computer-readable storage medium on which is stored a computer program for determining a selection area in an environment for a mobile device, the computer program, when executed by a computer, causing the computer to perform the following steps:
providing sensor data obtained using a sensor system in the environment, the sensor data characterizing a position and/or orientation of an entity in the environment;
determining, based on the sensor data, the position and/or orientation of the entity in a map provided for navigation of the mobile device;
providing specification data obtained using the sensor system, the specification data characterizing the selection area;
determining the selection area in the map based on the specification data; and
providing information about the selection area to the mobile device, the information about the selecting area instructing the mobile device to correspondingly take the selection area into account when navigating.
